(19) United States
(12) Patent Application Publication
(10) Pub. No.: US 2008/0169673 A1
(43) Pub. Date: Jul. 17, 2008

(54) CARGO BODY FOR A TRUCK AND TRUCK MADE THEREOF

(76) Inventor: Andre Lavoie, Trois-Rivieres (CA)

Correspondence Address: BERESKIN AND PARR, 40 KING STREET WEST, BOX 401, TORONTO, ON, M5H 3Y2, omitted

(21) Appl. No.: 12/014,957

(22) Filed: Jan. 16, 2008

Related U.S. Application Data
(60) Provisional application No. 60/885,107, filed on Jan. 16, 2007.

(51) Int. Cl. B62D 33/04

(52) U.S. Cl. 296/182.1

(57) ABSTRACT

A cargo body for a truck having a frame and a cab comprises a main component, a front component and a compliant joint. The main component defines a roof and connected sidewalls. The main component, which has a front end and a rear end, is adapted to be ultimately attached to the frame. The front component is adapted to be attached to the cab. The compliant joint is located between and in contact with the front component and the front end of the main component. The compliant joint is adapted to allow relative displacement between the main component and the front component.

### FIELD OF THE INVENTION

The present invention generally relates to the field of automotive vehicles. More specifically, the invention relates to a cargo body for a truck.

### BACKGROUND OF THE INVENTION

Pick-up trucks are quite popular for many small enterprise owners such as contractors, electricians, plumbers, etc. In place of a trunk, pick-up trucks have a truck bed surrounded by sides and a rear door. This truck bed is used to carry different types of objects. Very often, entrepreneurs equip their pick-up truck with a cap that sits atop the sides of the truck bed to provide an enclosed cargo area and keep their equipment safe from the environment and from theft.

Two types of caps exist: a low profile cap, whose top is more or less at the same level than a roof of a cab of the truck and a high profile cap, which provides added headroom so that an owner can work in the cargo area. However, none of these types of caps integrate well with the cab of the truck, as a gap needs to be left between the cap and the cab. As it is well known in the art, cracks occur in the cap when the cap is attached to the cab. Indeed, even under normal usage conditions, a truck frame slightly twists. This creates a relative displacement between the truck bed and the cab and induces stresses at the cap/cab joint. This is why most cap manufacturers exclusively attach their caps to the truck bed and not to the cab.

Unfortunately, because the gap needs to be designed in between the cap and the cab, caps always look like an add-on to the truck. This is especially apparent with the high profile caps whose front portion, higher than the cab roof, reaches forward over the cab in an effort to more or less create an impression of a continuous profile with a windshield of the truck. A long, unattractive gap is therefore apparent between the cab roof and the front portion of the cap.

The exact same thing holds true for cargo bodies mounted on cutaway trucks or on a chassis-cab trucks. In this case, the cargo bodies are directly mounted on the frame of the truck, but there is no contact with the cab. Once again, the cargo bodies look like an add-on to the truck.

There is therefore a need for a cargo body that integrates well with a truck while being resistant to stresses induced by the twisting of a truck frame.

### SUMMARY OF THE INVENTION

It is an object of the present invention to provide a cargo body for a truck that overcomes or mitigates one or more disadvantages of known truck cargo bodies, or at least to provide a useful alternative.

Advantageously, the present invention provides a cargo body that integrates well with a truck while being resistant to stresses induced by the twisting of a truck frame.

In accordance with an embodiment of the present invention, there is provided a cargo body for a truck having a frame and a cab. The cargo body comprises a main component, a front component and a compliant joint. The main component defines a roof and connected sidewalls. The main component, which has a front end and a rear end, is adapted to be ultimately attached to the frame. The front component is adapted to be attached to the cab. The compliant joint is located between and in contact with the front component and the front end of the main component. The compliant joint is adapted to allow relative displacement between the main component and the front component. Preferably, the compliant joint is an elastomeric seal.

In accordance with another embodiment of the present invention, there is provided a truck comprising a frame, a cab and a cargo body. The cargo body comprises a main component, a front component and a compliant joint. The main component defines a roof and connected sidewalls. The main component, which has a front end and a rear end, is attached to the frame. The front component is attached to the cab. The compliant joint is located between and in contact with the front component and the front end of the main component. The compliant joint is adapted to allow relative displacement between the main component and the front component.

In accordance with another embodiment of the present invention, there is provided a cargo body for a truck having a frame and a cab. The cargo body comprises a main component, a front component and a compliant joint. The main component is made of a floor, a plurality of parallel ribs and a skin. The floor is adapted to be directly attached to the frame. The plurality of parallel ribs is adapted to be attached to the floor and is adapted to be placed transversally and perpendicularly to the floor. The skin is adapted to envelop and to be attached to the plurality of ribs. The front component is adapted to be attached to the cab. The compliant joint is adapted to be installed between the main component and the front component. The compliant joint is adapted to allow relative displacement between the main component and the front component once assembled.

### BRIEF DESCRIPTION OF DRAWINGS

These and other features of the present invention will become more apparent from the following description in which reference is made to the appended drawings wherein:

FIG. 1 is a rear perspective view of a cargo body installed on a truck in accordance with an embodiment of the invention;

FIG. 2 is a rear perspective view of a cargo body installed on a truck in accordance with another embodiment of the invention;

FIG. 3 is a front perspective view of the cargo body and truck of FIG. 2;

FIG. 4 is a cross-sectional view of a compliant joint of FIG. 2;

FIG. 5 is an exploded view of the cargo body of FIG. 2.

### DETAILED DESCRIPTION OF THE INVENTION

The present invention provides a cargo body adaptable to different types of trucks such as pick-up trucks, cutaway trucks or chassis-cab trucks. The structure of the cargo body is specifically designed such as to integrate well with the cab of each of these trucks. Indeed, the cargo body comprises three main components: a front component, a main component and a compliant joint. The front component is adapted to be mounted on the cab of the truck. The main component is mounted on a frame of the truck. The compliant joint is mounted in between the front and the main components so as to decouple the cab from the cargo body. Hence, the cargo body may integrate well with a truck while still being resistant to stresses induced by the twisting of the frame of the truck.

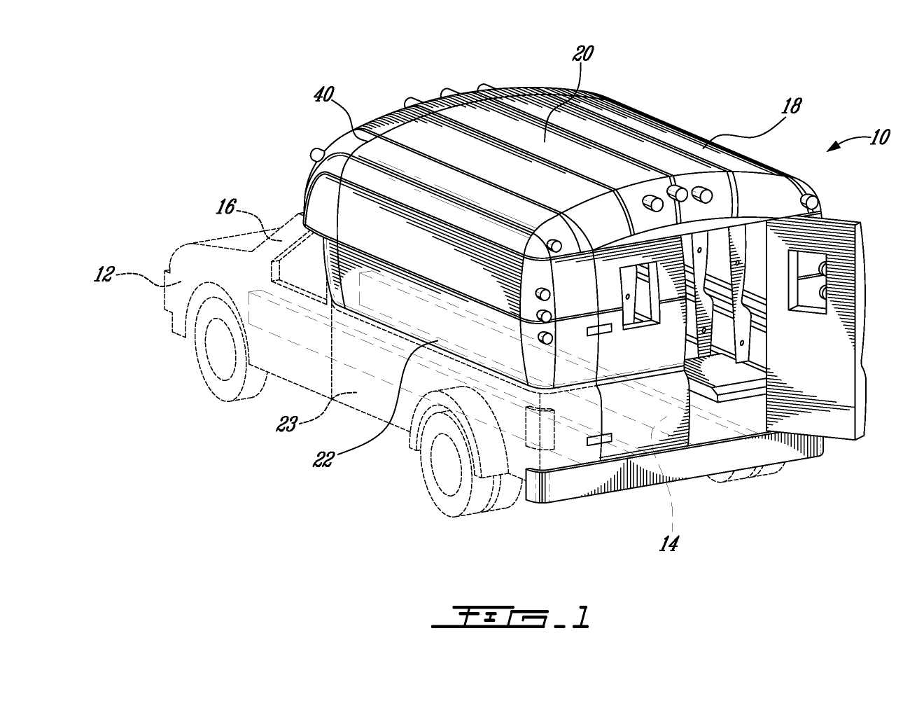

FIG. 1 depicts an embodiment of the present invention where a cargo body 10 is fitted to a truck 12. The truck 12 has a frame 14 and a cab 16. The truck 12 may be a pick-up truck, a cutaway truck or chassis-cab truck.

The cargo body 10 comprises a main component 18 defining a roof 20 and connected sidewalls 22. The main component 18 of the cargo body 10 may be constructed in different ways. Indeed, it may be constructed from composite materials, preferably using a foam core to reduce weight and increase rigidity. Alternatively, the main component 18 may be manufactured from a light and relatively inexpensive structure made of a plurality of parallel ribs covered by a skin. The main component 18 is adapted to be ultimately attached to the frame 14. For example, in the present embodiment, the cargo body 10 is fitted to a cargo bay 23 of a non-modified standard pick-up truck. In this case, the main component 18 is attached to the cargo bay 23 which itself is fixed to the frame 14 of the pick-up truck.

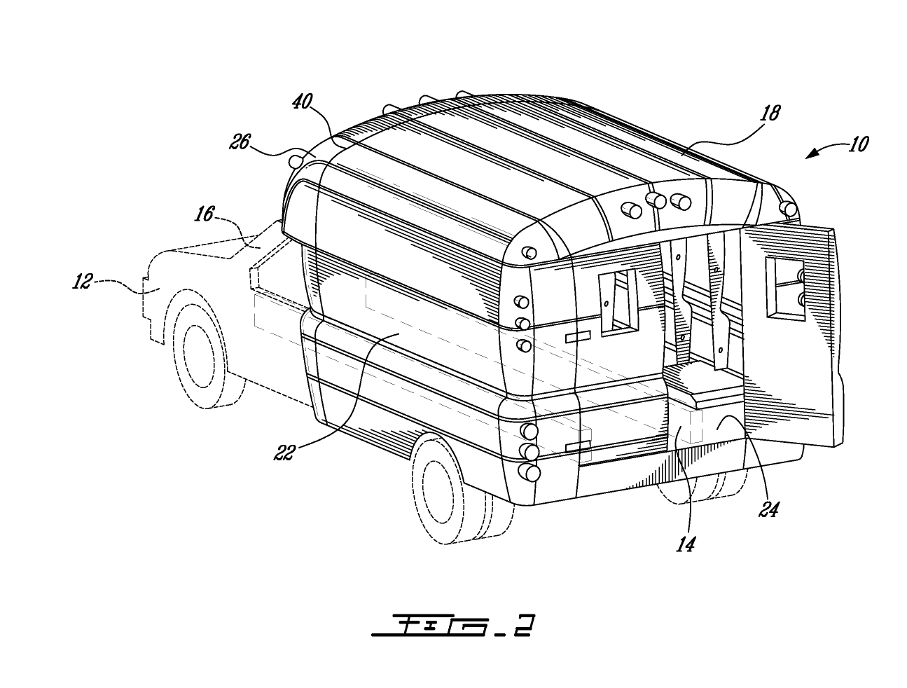

Turning now to FIG. 2, there is depicted another embodiment of the present invention. In this embodiment, the cargo body 10 is fitted to either a cutaway truck or a chassis-cab truck. The main component 18 is directly attached to the frame 14 through a floor 24 joining the sidewalls 22. The cargo body 10 further comprises a front component 26 which is adapted to be attached to the cab 16 of the truck 12.

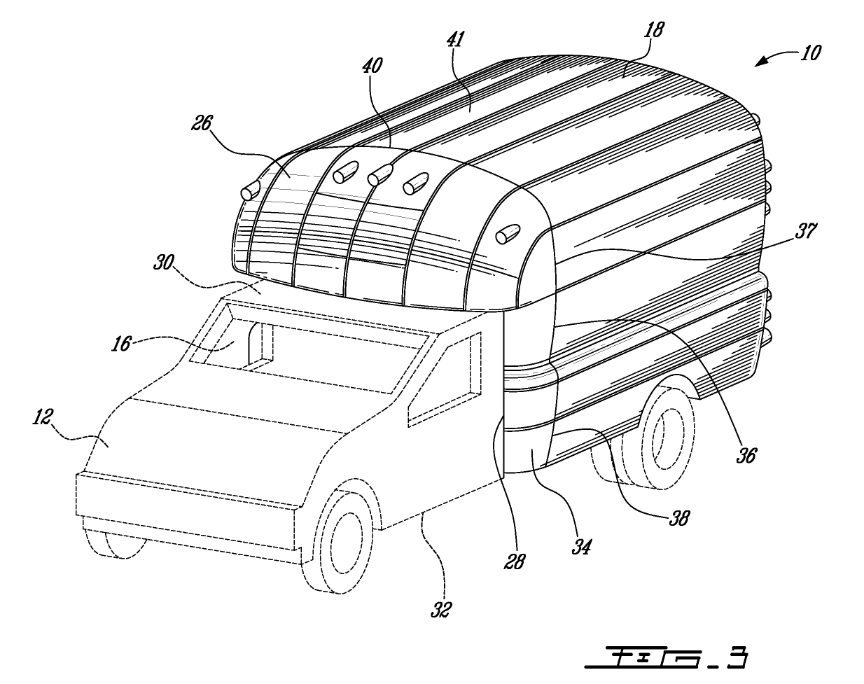

Concurrently referring to FIGS. 2 and 3, the front component 26 may have a matching outline 28. The matching outline 28, best shown in FIG. 3, may not only be on the cab top 30 of the cab 16, but may also extend downwardly to the cab floor 32 thereby defining front component sides 34. This matching outline 28 is designed to tightly match the cab 16 so as to provide an aesthetically pleasing continuous profile between the cab 16 and the cargo body 10, contributing to an integrated look of the truck 12. The front component 26 also has a transversal exterior outline 36 which is similar to a transversal exterior outline of a front end 38 of the main component 18. The front component sides 34 are designed to match the sidewalls 22 along the transversal exterior outline 36. The front component 26 therefore provides a transition between the cab 16 and the cargo body 10. The transversal exterior outline 36 is divided in an upper and a lower convex portions 37 and 38. These two portions are discontinuous where they meet together.

In order to provide added storage space inside the cargo body 10, it is possible to extend a portion of the front component 26 above the cab top 30.

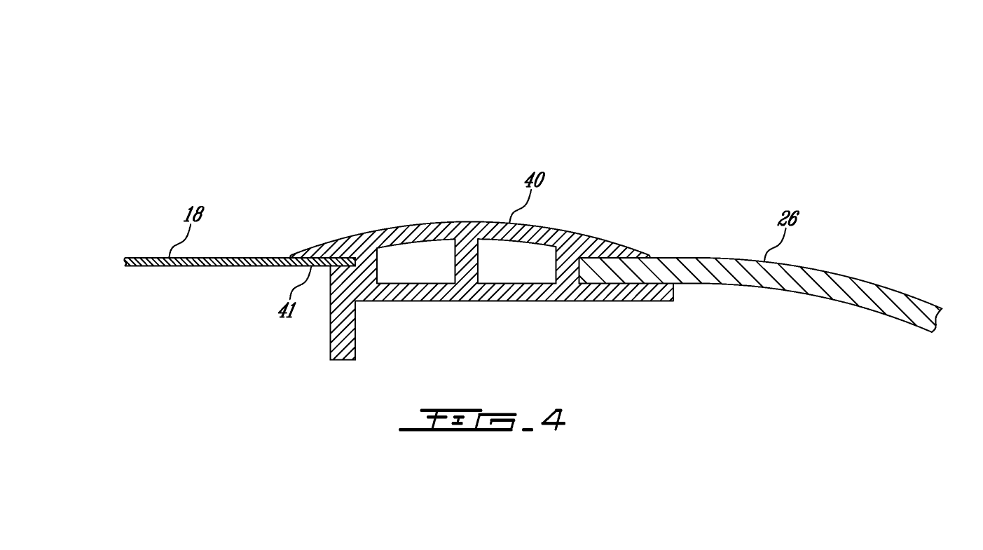

A compliant joint 40 is used in between and in contact with both the front component 26 and a front end 41 of the main component 18. This compliant joint 40 is designed to allow relative displacement between the main component 18 and the front component 26. By allowing such relative displacement, a front portion of the truck 12, namely the cab 16, moves with respect to a rear portion of the truck 12, where the main component 18 is fixed to the frame 14. This is caused by the frame 14 flexing and twisting under load during normal use. This possibility of allowing relative displacement between the front component 26 and the main component 18 prevents cracks from occurring in the cargo body 10. The compliant joint 40 is designed to also seal the front component 26 with the main component 18 so that water does not infiltrate inside the cargo body 10. The compliant joint 40 may be made of an elastomeric material. The compliant joint 40 may be installed near an exterior surface of the main component 18 in order to provide a smooth transition between exterior surfaces of the front component 26 and the main component 18. The installation of the compliant joint is better shown in FIG. 4 to which we now refer. Both the front end 41 of the main component 18 and the front component 26 are inserted in opposed grooves in the compliant joint 40. Such an installation prevents water from seeping in the cargo body. Any relative motion between the main component 18 and the front component 26 is allowed by deformation of the compliant joint 40. It will be readily apparent to a person skilled in the art that many variants of the compliant joint design could be used and these are intended to be covered by the present invention.

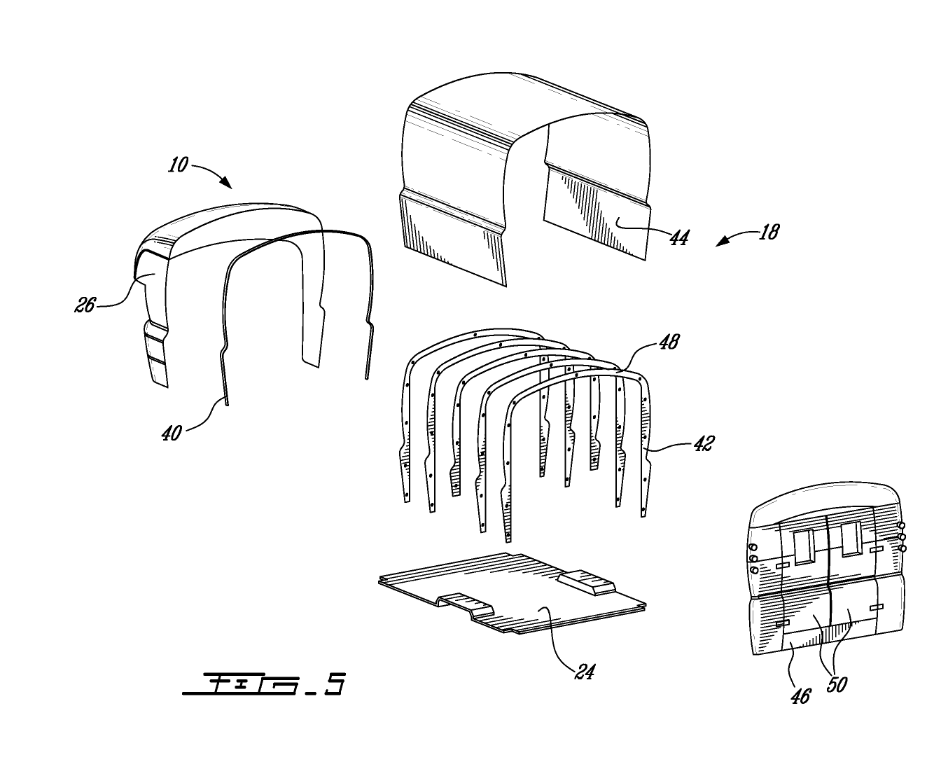

Turning now to FIG. 5, there is depicted another embodiment of the present invention. In this embodiment, all of the components of the cargo body 10 are manufactured, but partly, or not at all assembled. This creates a cargo body kit that can be easily shipped to either an assembler or to an end user for easy assembly.

The main component 18 has its structure made of a plurality of parallel ribs 42 attached to the floor 24. The ribs 42 are placed transversally and perpendicularly to the floor 24 and are enveloped by a skin 44, attached to the ribs 42. The skin 44 may be attached to the ribs 42 by many known methods such as by using adhesives, welding or riveting. The ribs 42, the skin 44 and the floor 24 may be made of aluminum.

A rear component 46 may be attached to the main component 18 to close its rear end 48. The rear component 46 is equipped with one or two doors 50. Both the rear component 46 and the front component 26 may be made of composite materials. The front component 26 may be attached to the main component 18 through the compliant joint 40.

It will be apparent to a person skilled in the art that the different components may be placed in a box or similar contained such as to minimize packaging dimensions. For example, the ribs 42, compliant joint 40, rear component 46 and front component 26 may be laid flat on the floor 24 and bundled together while the skin may be rolled.

Because of its flexibility and versatility, it is also possible to manufacture main components 18 of standard dimensions, with various front components 26, each of which corresponds to a particular make of vehicle. It would thus allow a dealer of cargo bodies to keep in stock only one model of main component 18, with multiple models of front components 26, each corresponding to a specific make of cab. To service a customer, the dealer would then need to select an appropriate front component 26 for the customer's cab, use one of the main components 18, and affix both to the customer's vehicle and connect them with the compliant joint 40. Standardizing the main compartment could further reduce costs of production and result in interesting savings for the customer.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

I claim:

1. A cargo body for a truck having a frame and a cab, said cargo body comprising:
a main component defining a roof and connected sidewalls, said main component being adapted to be ultimately attached to the frame, said main component having a front end and a rear end;
a front component adapted to be attached to the cab; and
a compliant joint between and in contact with said front component and said front end of said main component,
wherein said compliant joint is adapted to allow relative displacement between said main component and said front component.

2. The cargo body as defined in claim 1 wherein said compliant joint is an elastomeric seal and is substantially near an exterior surface of said main component.

3. The cargo body as defined in claim 2 wherein said seal is attached to said front end of said main component.

4. The cargo body as defined in claim 2 wherein said front component has a matching outline adapted to tightly match the cab.

5. The cargo body as defined in claim 4 wherein said front component comprises front component sides extending downwardly to match said sidewalls of said main component.

6. The cargo body as defined in claim 5 wherein a portion of said front component projects away from said front component sides over the cab.

7. The cargo body as defined in claim 5 wherein said front component has a transversal exterior outline similar to a transversal exterior outline of said front end of said main component.

8. The cargo body as defined in claim 7 wherein said main component is adapted to fit in a cargo bay of a pick-up truck.

9. The cargo body as defined in claim 7 further comprising a floor attached to said sidewalls of said main component.

10. The cargo body as defined in claim 9 wherein said floor is adapted to be attached directly to the frame, said truck being a cutaway truck or a chassis-cab truck.

11. The cargo body as defined in claim 10 wherein said main component is made of:
a plurality of parallel ribs attached to said floor and placed substantially transversally and substantially perpendicularly to said floor; and
a skin enveloping and attached to said plurality of ribs,
said main component further comprising a rear component equipped with at least one door, said rear component being attached to said rear end of said main component.

12. The cargo body as defined in claim 11 wherein said ribs and said skin are made of aluminum and said front component and said rear component are made of a composite material.

13. The cargo body as defined in claim 12 wherein said main component has a convex upper transversal exterior outline joined to a convex lower transversal exterior outline, said upper transversal exterior outline and said lower transversal exterior outline having a discontinuity at their junction.

14. A truck comprising:
a frame;
a cab; and
a cargo body having:
a main component defining a roof and connected sidewalls, said main component being attached to said frame, said main component having a front end and a rear end;
a front component attached to the cab; and
a compliant joint between and in contact with said front component and said front end of said main component,
wherein said compliant joint is adapted to allow relative displacement between said main component and said front component.

15. The truck as defined in claim 14 wherein said compliant joint is an elastomeric seal placed substantially near an exterior surface of said front end of said main component.

16. The truck as defined in claim 15 wherein said front component comprises a matching outline adapted to tightly match said cab.

17. The truck as defined in claim 16 wherein said front component has a transversal exterior outline similar to a transversal exterior outline of said front end of said main component.

18. A cargo body for a truck having a frame and a cab, said cargo body comprising:
a main component having:
a floor adapted to be directly attached to the frame;
a plurality of parallel ribs adapted to be attached to said floor and adapted to be placed transversally and perpendicularly to said floor; and
a skin adapted to envelop and to be attached to said plurality of ribs;
a front component adapted to be attached to the cab; and
a compliant joint adapted to be installed between said main component and said front component,
wherein said compliant joint is adapted to allow relative displacement between said main component and said front component once assembled.

19. The cargo body as defined in claim 18 further comprising a rear component having at least one door, said rear component being adapted to be attached to said main component.

20. The cargo body as defined in claim 19 wherein said floor, said plurality of ribs and said skin are made of aluminum, wherein said front component and said rear component are made of a composite material and wherein said compliant joint is made of an elastomeric material.
